(19) United States
(12) Patent Application Publication
(10) Pub. No.: US 2024/0191959 A1
(43) Pub. Date: Jun. 13, 2024

(54) INTEGRATED INTELLIGENT LOCKING SYSTEM

(71) Applicant: Drive2Data Inc., Miami, FL (US)

(72) Inventors: Fabio Orfanini, Miami, FL (US); Gaetano Lo Presti, Latina (LT) (IT); Fabrizio Pinto, Roma (RM) (IT); Francesco Princi, Nettuno (RM) (IT); Giorgio Rubiu, Aprilia (LT) (IT)

(73) Assignee: Drive2Data Inc., Miami, FL (US)

(21) Appl. No.: 18/076,673

(22) Filed: Dec. 7, 2022

(51) Int. Cl. F41A 17/06; H04W 12/06

(52) U.S. Cl. CPC F41A 17/066; F41A 17/063; H04W 12/068

(57) ABSTRACT

An intelligent integrated locking system associated to a limited access element comprises a locking element apt to physically prevent an access to the limited access element; a user recognition device apt to recognize an authorized user; and a position detector apt to detect the position of the limited access element, the locking element being triggered into a safe use mode only upon receiving a first authorization command from the user recognition device and a second authorization command from the position detector.

### BACKGROUND

### Technical Field

The present disclosure relates to an integrated intelligent locking system.

The disclosure particularly, but not exclusively, relates to an integrated intelligent locking system preventing access to dangerous places or tools, in particular firearms and the following description is made with reference to this field of application for convenience of explanation only.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

As it is known, there are places that should be safely accesses only upon authorization as well as tools that should be handled only by trained personnel. Unauthorized access to such dangerous places or tools can cause accidents having very serious consequences for the people involved, leading even to death.

This is the case, for example, of unauthorized access to a storages of hazardous materials, such as materials capable, if not handled correctly, of releasing gases that can cause even serious damage to anyone who breathes them, in particular toxic gases.

Equally dangerous is the case of unauthorized access to sharp tools, such as a chainsaw, or firearms, which can injure, even fatally, a user who comes into possession of them but does not fully understand how they work.

Serious if not catastrophic consequences can also occur in the event that a felon gets into possession of dangerous tools or hazardous materials or firearms.

In relation to firearms, there are almost daily reports about injuries or killing of people due to gunshot wounds, these incidents largely involving young people, in particular under the age of 24, usually hit by someone having a same age.

In the USA, official reports stat that an average of 492 people unintentionally die every year from accidental firearms shots and in the period between January and February 2022, 209 children (aged between 0 to 17) died of gunshots, others 519 children having been injured.

The most serious consequences of an improper use of dangerous devices, in particular firearms, are usually linked to public places, such as schools or courts, also referred to as “sensitive areas”.

Over the years, various mechanical and electronic solutions have been developed aimed at preventing access to dangerous places or tools, in particular firearms, such as, for example, increasingly unassailable locks, which combine mechanical devices with a high level of safety, such as using non-duplicable numeric coded keys as well as software protection measures, such as biometric or voice recognition systems.

Unfortunately, all of these solutions are not tamper-proof, especially for a felon with a strong motivation.

### BRIEF SUMMARY

An embodiment of this disclosure is directed to an integrated intelligent locking system being able to guarantee a suitable protection of limited access elements, comprising areas with restricted access, such as storage areas of potentially harmful materials, or dangerous devices, such as sharp tools or firearms, in this way overcoming the problems tied to the prior art solutions.

According to an aspect of the disclosure, the intelligent integrated locking system associated to a limited access element comprises a locking element apt to physically prevent an access to the limited access element; a user recognition device apt to recognize an authorized user; and a position detector apt to detect the position of the limited access element, the locking element being triggered into a safe use mode only upon receiving a first authorization command from the user recognition device and a second authorization command from the position detector.

The characteristics and advantages of the integrated intelligent locking system according to the disclosure will be apparent from the following description of embodiments thereof given by way of indicative and non-limiting example with reference to the annexed drawings.

### BRIEF DESCRIPTION OF THE SEVERAL VIEWS OF THE DRAWINGS

FIG. 1 schematically shows a general overview of the working of an integrated intelligent locking system according to an embodiment of the disclosure;

FIG. 2 schematically shows the integrated intelligent locking system and an infrastructure associated thereto according to an embodiment of the disclosure;

FIG. 3 schematically shows a limited access element provided with an integrated intelligent locking system according to an embodiment of the disclosure;

FIGS. 4 to 6 schematically show different parts of the integrated intelligent locking system according to an embodiment of the disclosure;

FIGS. 7A and 7B schematically show a firearm provided with an integrated intelligent locking system according to embodiments of the disclosure;

FIGS. 8A and 8B schematically show a firearm and a corresponding holster thereof provided with an integrated intelligent locking system according to embodiments of the disclosure;

FIG. 9 schematically shows a general overview of the working of a firearm provided with an integrated intelligent locking system according to an embodiment of the disclosure;

FIG. 10 schematically shows an analysis data architecture associated with an operating center for the integrated intelligent locking system according to an alternative embodiment of the disclosure.

### DETAILED DESCRIPTION

With reference to such figures, an intelligent integrated locking system is described which finds particular application in limiting the access to areas wherein potentially harmful materials are stored or to potentially dangerous devices, such as sharp tools or firearms. In the following, reference will be made generically to a limited access element to indicate an area or a device which is protected by the integrated locking system according to the present disclosure, i.e. to which the access is allowed only after authorization.

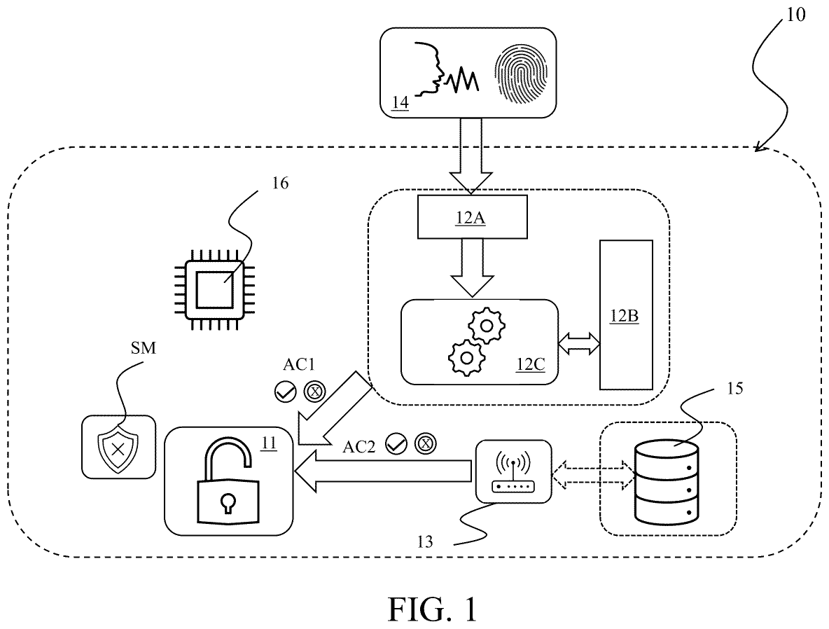

More particularly, with reference to FIG. 1, the integrated intelligent locking system 10 includes a locking element 11, a user recognition device 12 and a position detector 13 coupled one another.

According to an embodiment of the disclosure, the locking element 11 is able to physically prevent an access to the limited access element associated with the integrated intelligent locking system 10 for safety reasons. The locking element 11 can be removable or integral with the limited access element itself and can be equipped in an independent battery or associated with an internal energy source of the limited access element. More particularly, the locking element 11 can be a separately produced element which is associated to a limited access element, such as a lock to a storage area or a weapon, already on the market. Alternatively, locking element 11 can be integrated within the limited access element at the production stage.

In a preferred embodiment of the disclosure, the user recognition device 12 is a biometric identification engine comprising at least one between a voice recognition device and a fingerprint scanner, being able to recognize an authorized user or a plurality of authorized users by means of their biometric data 14, for instance a voice command and/or fingerprints being previously stored in the user recognition device 12. The stored voice command and/or fingerprints are thus a certified recognition key of the authorized user.

In particular, the user recognition device 12 comprises an interface 12A able to collect the biometric data 14 of the user and a memory unit 12B, able to store biometric data of authorized user(s). According to an embodiment, the interface 12A of the user recognition device 12 may comprise a microphone able to collect a voice command and/or a fingerprint scanner, in case coupled and interacting with one another.

The user recognition device 12 further comprises an engine 12C being connected to the interface 12A and to the memory unit 12B and able to compare the collected biometric data 14 with the stored ones so as to identify a user as an authorized one, such as the owner of the integrated locking system 10.

The user recognition device 12 can be integrated within the limited access element or associated to a user phone or PDA or another electronic device being held by the user and suitably connected to the locking element 11.

Only after the user recognition device 12 has positively identified an authorized user, a first authorization command AC1 is provided to the locking element 11 so as to unlocking it by triggering a safe use mode SM. The first authorization command AC1 could be in the form of binary signal having a first state “access authorized” and a second state “access denied”.

In case of a voice recognition as user recognition device 12, a specific voice command, for instance a preset word or sequence of words, could be required from the user in order to unlock the locking element 11. However, the first authorization command AC1 is only provided by the user recognition device 12 to the locking element 11 when the specific voice command comes from a stored voice, i.e. an authorized user, i.e. after the engine 12C of the user recognition device 12 has recognized a so-called “voice print” of the user, making it impossible for any other individual to grant access to the limited access element protected by the integrated intelligent locking system 10.

In particular, the memory unit 12B comprises unique voice print(s) being obtained by a recording of the authorized user voice(s), for instance a minute long voice recording to be used by the engine 12C in order to recognize authorized user(s) having collected their biometric data 14, in particular a specific voice command.

The engine 12C may use Machine Learning and Deep Learning algorithms to identify the authorized user(s). More particularly, in case of a voice recognition device as user recognition device 12, the engine 12C may provide for eliminating the background sounds so as to enhance the recognition of the voice of the user.

In a preferred embodiment, the user recognition device 12 is a portable device, for instance a mobile phone provided with an interface 12A for biometric data 14, such a microphone and comprises radio connection means to the locking element 11 in order to provide the first authorization command AC1.

Moreover, the position detector 13, which is also coupled to the mechanical locking element 11, is apt to detect the position of the integrated intelligent locking system 10 and to compare it with sensitive areas being prestored in the integrated intelligent locking system 10 so as to send to the locking element 11 a second authorization command AC2. The second authorization command AC2 could be in the form of binary signal having a first state “access authorized” and a second state “access denied”.

According to an embodiment, the position detector 13 may be coupled to a position database 15 storing the sensitive areas.

In particular, the sensitive areas may correspond to locations wherein the use of the limited access element is only allowed, also indicated as authorized areas. In this case, the second authorization command AC2 is provided to the locking element 11 only if the position of the integrated intelligent locking system 10 is within a stored sensitive area. This could be the case wherein a dangerous device or tool, in particular a firearm, can be used only in selected areas, for instance a construction site, a owner house, a shooting range, to name few.

Alternatively, the sensitive areas may correspond to locations wherein the use of the limited access element is never allowed, also indicate as prohibited areas. In this case, the second authorization command AC2 is provided to the locking element 11 only if the position of the integrated intelligent locking system 10 is outside all the stored sensitive areas. This could be the case wherein a dangerous device or tool, in particular a firearm, can never be used in specific public spaces, for instance school, library, public offices, churches, courts, to name few.

According to an embodiment, the position detector 13 may also comprise an accelerometer, able to detect and provide data relating the movements of the integrated intelligent locking system 10 comprising the position detector 13.

The locking element 11 is triggered into the safe use mode SM only upon receiving the first authorization command AC1 from the user recognition device 12 and the second authorization command AC2 from the position detector 13.

The integrated locking system 10 can be also equipped with a device for remote data transmission, such as a data SIM card 16.

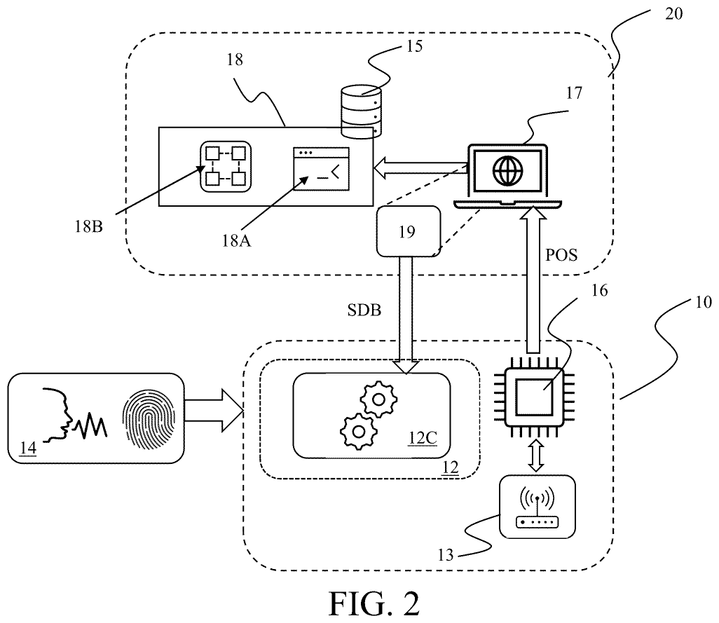

The integrated intelligent locking system 10 could be also in communication with an infrastructure 20, which includes an operating center 17 and a software interface 18, in turn comprising at least one management software 18A and a blockchain security system 18B, as shown in FIG. 2.

In particular, the operations center 17 is able to acquire and store unique identification codes of integrated intelligent locking systems 10, for instance, serial numbers identifications of locking elements 11 and of portable devices including the corresponding user recognition devices 12.

According to an embodiment, the operating center 17 may comprise a store unit 19 able to store data of the owners of the integrated intelligent locking systems 10, in particular their stored biometric data SBD and provide the same to the integrated intelligent locking system 10, in particular to the engine 12C of the user recognition device 12. The integrated intelligent locking system 10 may also communicate its position POS to the operating center 17 by means of its data connection means, in particular the data SIM card 16 associated to the position detector 13.

According to an embodiment, the integrated intelligent locking system 10 periodically transmits its unique identification code to the operating center 17. Furthermore, in case the position detector 13 also comprise an accelerometer, the integrated intelligent locking system 10 may also send information relating to the acceleration state of the integrated intelligent locking system 10, i.e. information relating any movement/use of the integrated intelligent locking system 10 and of the limited access element associated thereto.

Furthermore, the management software 18A is used to manage the sensitive areas, being authorized or prohibited ones, for instance comprising or being coupled to the position database 15, and the blockchain security system 18B is used to manage critical information related to the unique identification codes of the integrated intelligent locking system 10 and to the biometric data of the authorized users, which are recorded by means of a blockchain so as to increase the security of the restricted access elements associated with the integrated intelligent locking systems 10.

The operating center 17 may be in a private server, in particular a cloud server, or a public server, in particular within a government office facility.

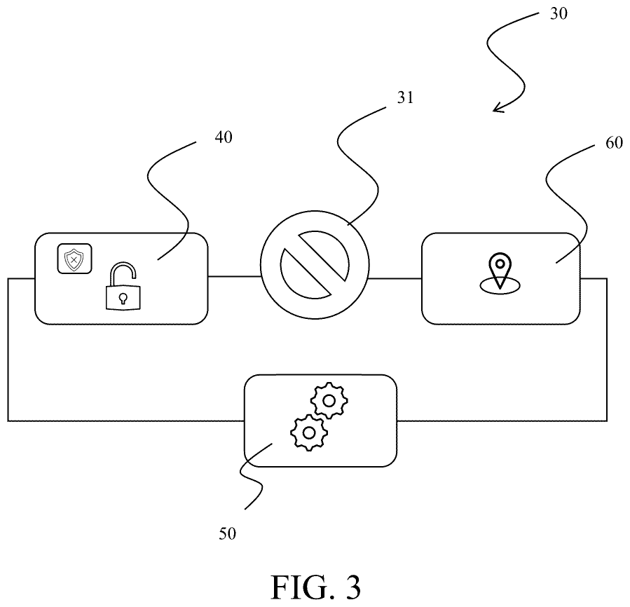

According to a preferred embodiment, as shown in FIG. 3, the integrated intelligent locking system 30 associated to a limited access element 31 may comprise an RF radio-controlled electromechanical actuator 40 and an RF radio emitter 60 coupled to the limited access element 31 and to a portable computing unit 50.

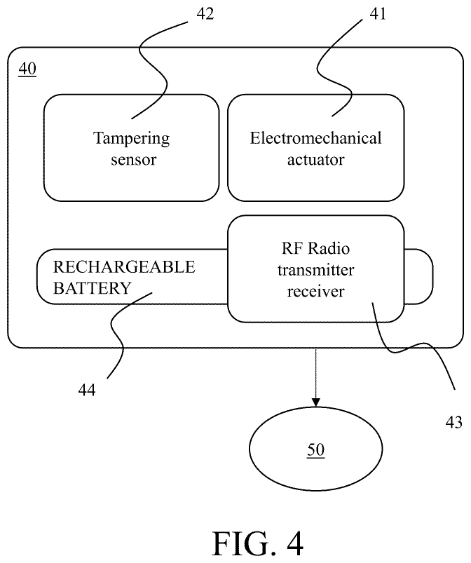

More in particular, as shown in FIG. 4, the RF radio-controlled electromechanical actuator 40 comprises an electromechanical actuator 41 able to prohibit the use of the limited access element 31 as well as a tamper sensor 42, capable of signaling any attempts of unauthorized access to the portable computing unit 50.

The RF radio-controlled electromechanical actuator 40 is used to mechanically forbid the use of the limited access element 31 and may be removable or integrated with such an element.

The RF radio-controlled electromechanical actuator 40 may further comprise an RF radio transmitter receiver 43 able to radio connect with the portable computing unit 50. According to a preferred embodiment, the RF radio transmitter receiver 43 is a very low power radio transceiver using a frequency of 900 MHz or 2.4 GHz.

Finally, the RF radio-controlled electromechanical actuator 40 may comprise a rechargeable battery 44, able to provide energy to any of the electromechanical actuator 41, tamper sensor 42 and RF radio transmitter receiver 43 of the RF radio-controlled electromechanical actuator 40.

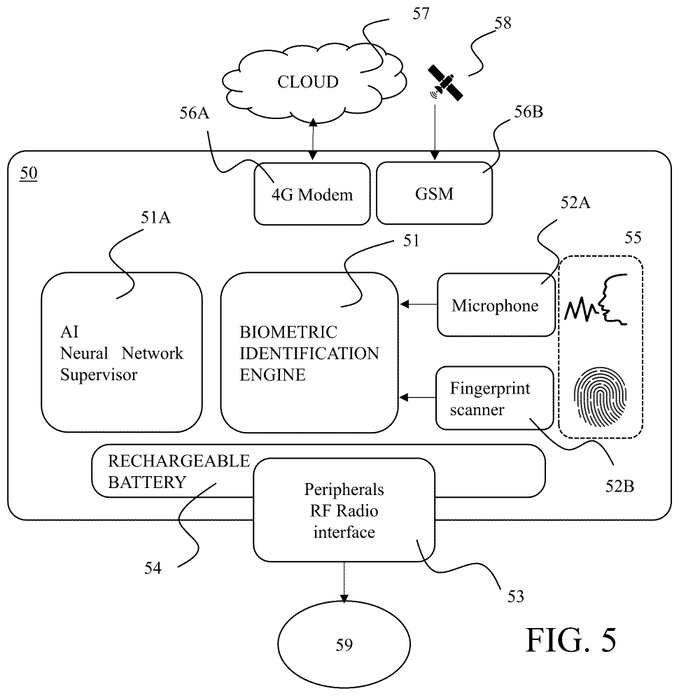

The portable computing unit 50, as shown in greater detail in FIG. 5, may comprise a biometric identification engine 51 receiving biometric data 55 from suitable interface devices, in particular a microphone 52A and/or a fingerprint scanner 52B. Moreover, the portable computing unit 50 may further comprise an AI neural network supervisor 51A being apt to manage tracing functions and authorize the use of the limited access element 31 upon identification of an authorized user by their biometric data 55.

According to an embodiment, the portable computing unit 50 comprises first connection means 56A, for instance a 4G Modem device, to the cloud 57 and second connection means 56B, for instance a GSM device, to the global position system 57.

The portable computing unit 50 may further comprise a peripherals RF radio interface 53 able to radio connect with the RF radio-controlled electromechanical actuator 40 and the RF radio emitter 60 by means of suitable peripherals 59 and a rechargeable battery 54 able to provide energy to any the first connection means 56A and second connection means 56B, the biometric identification engine 51, the AI neural network supervisor 51A, the microphone 52A, the fingerprint scanner 52B and the peripherals RF radio interface 53.

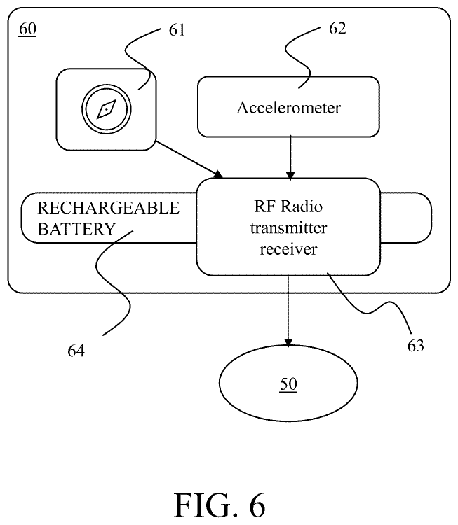

As further shown in FIG. 6, the RF radio emitter 60 may in turn comprise a position detector 61, such a gyroscope, and an accelerometer 62 connected to an RF radio transmitter receiver 63 able to radio connect with the portable computing unit 50. According to a preferred embodiment, the RF radio transmitter receiver 63 is a very low power radio transceiver using a frequency of 900 MHz or 2.4 GHz.

Finally, the RF radio emitter 60 may comprise a rechargeable battery 64, able to provide energy any of the position detector 61, accelerometer 62 and RF radio transmitter receiver 63.

According to a preferred embodiment, the RF radio emitter 60 is able to be concealed in a permanent form within the limited access element 31 and to periodically transmit its unique identification code to a corresponding operating center. Thanks to the presence of the accelerometer 62, such a RF radio emitter 60 is also able to transmit information relating to the movement/use of the limited access element.

The RF radio emitter 60 may be for instance inserted into a handle or a magazine of a weapon but also being a separate device attached, for instance glued to the weapon.

The RF radio emitter 60 may be also used as a georeferencing device for the limited access element 31, in particular a weapon, which can thus be traced, for instance by using the cellular network.

In this way, the RF radio emitter 60 is able to count the fast acceleration of the limited access element 31 associated therewith, tied for instance to gunshots fired by a firearm, the RF radio emitter 60 being in this way able to provide a number of fired shots or a number of remaining bullets, in case the limited access element 31 is a firearm.

Moreover, the RF radio emitter 60 may transmit a position signal in a secured way, for instance a Bluetooth® signal which can be detected by portable devices (smartphones, tablets, PDAs) within a detection range. In turn, the portable devices can transmit such position signal to a Cloud network, thus allowing the position of the RF radio emitter 60 to be shown in a map. This chain of transmissions of the position signal is made in an anonymous and crypted form, so as to guarantee the users privacy.

The information transmitted by the RF radio emitter 60 are also used by the AI neural network supervisor 51A to verify a position within a safe use area of the RF radio emitter 60 and thus of the locking element 11 of the limited access element 31.

In particular, the RF radio-controlled electromechanical actuator 40 and the RF radio emitter 60 are on board while the portable computing unit 50 is an external device, usually comprising an app to deal with the gathering of the biometric data 55, the identification of the authorized user(s) and the communication with the RF radio-controlled electromechanical actuator 40 and the RF radio emitter 60.

According to an embodiment, an architecture able to ensure a correct use of protected elements comprises:
a locking device;
a portable device; and
an operating center.

More particularly, the locking device may comprise:
an electromechanical actuator;
position detection means including a GPS connection device, a 4G Modem device or a connection to the cellular network;
a rechargeable battery;
a data SIM card; and
an accelerometer and a gyroscope.

The portable device may also comprise:
interface devices to collect biometric data, such as a microphone
a biometric identification engine; and
radio connection means to the locking device.

Finally, the operating center may perform the following actions:
acquiring and storing the data relating to the protected elements and to the authorized users;
defining sensitive areas wherein the protected elements can access or being used, allowing a remote lock of such elements; and
using blockchains to store critical information.

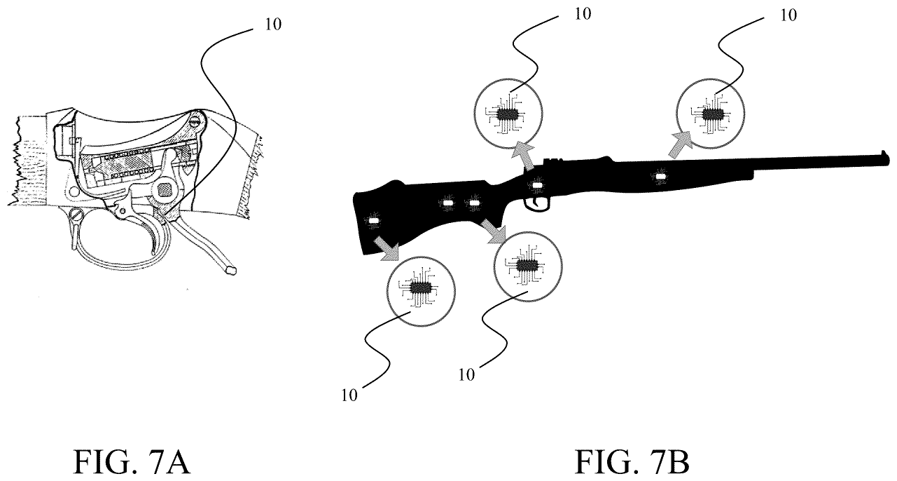

In a preferred embodiment, the integrated intelligent locking system 10 is used to prevent the incorrect use of a firearm. The integrated intelligent locking system 10 may be in the form of an external plug to be applied to an already existing firearm, as shown for instance in FIG. 7A or it can be embedded in the firearm during its manufacturing, in suitable locations as shown in FIG. 7B.

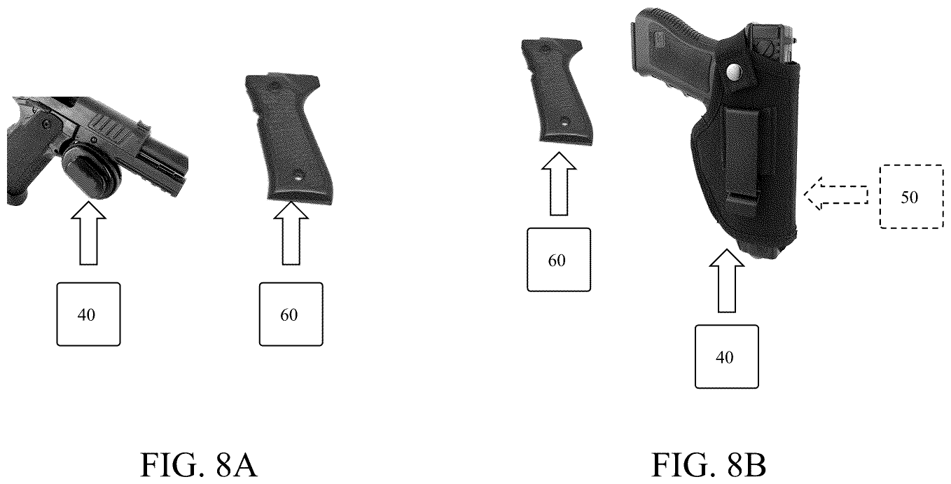

The integrated intelligent locking system 10 may be associated with a firearm by positioning the RF radio-controlled electromechanical actuator 40 in correspondence of the firing mechanism and the RF radio emitter 60 within the gun grip, as shown in FIG. 8A. Alternatively, the RF radio-controlled electromechanical actuator 40 may be used to block the opening of the gun holster, as shown in FIG. 8B. In this case, the holster may also comprise the portable computing unit 50.

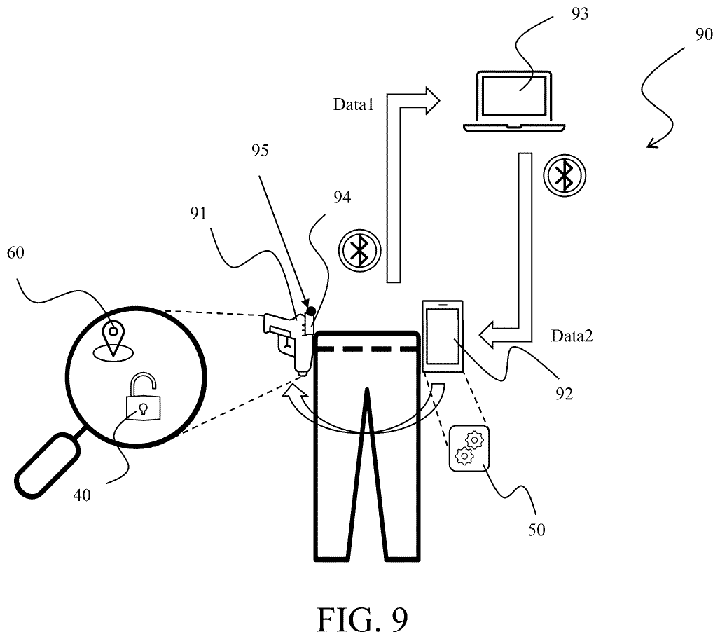

A communication mechanism 90 between the elements of an integrated intelligent locking system associated with a firearm is schematically shown in FIG. 9.

The firearm 91 comprises the RF radio-controlled electromechanical actuator 40 and the RF radio emitter 60 and is in communication with a portable device 92 including the portable computing unit 50. The portable device 92 is able to exchange data Data1 and Data2 with an operating center 93, for instance according to the Bluetooth protocol.

The firearm 91 may also comprise a display 94 provided with a push button 95 allowing the displaying for the used of information relating the use of such firearm 91, such a number of sharp accelerations of the firearms 91, a battery state, an ON/OFF status signal, a connected/not connected signal, to name few. In particular, the number of sharp accelerations can be used to indicate a number of fired gunshots, a number of left bullets, a number of sudden drops of the firearm 91 or a state of walk or run of the user wearing/holding the firearm 91.

The integrated intelligent locking system is configured according to the following phases:
S1: registration in unique identification code of the integrated intelligent locking systems to for a registry;
S2: association of the locking element 11 to the limited access element to be protected;
S3: recording of the biometric data, for instance the voices, of authorized user(s) by means of a portable device;
S4: generation of preset biometric data, for instance voice prints, to be used to identify the authorized user(s).

A further phase S5 could be provide, wherein the quality of the recorded biometric data are checked and that forces a repetition of phase S3 of recording of the biometric data if minimum operating requirements are not meet.

Cloud resources may be used to allow the configuration of the integrated intelligent locking system according to the above listed phases. Alternatively, a specific App could be provided to allow a configuration via smartphone.

After the configuration, the integrated intelligent locking system 10 can be used and an authorized used can trigger the safe use mode SM thereof using their voice and a specific voce command, if any, and/or their fingerprints. Moreover, the locking element 11, physically provided within the limited access element in order to prevent and access to the same, for instance its use, is completely under control of the portable computing unit 50 which not only allows it safe use mode SM upon identification of an authorized user but also prevent its removal without permission.

The RF radio emitter 60 of the integrated intelligent locking system 10 also provides for the identification of its position so that the safe use mode SM is tied to the sensitive areas, in particular triggered only if the limited access element is within one of the authorized areas or outside all of the prohibited areas.

In this way, the integrated intelligent locking system 10 allows a monitoring of the limited access element with respect to the sensitive areas, the authorized areas and the prohibited ones, and provides for an alarm signal, for instance an alarm sound, in case of a theft or an authorized removal of such a limited access element, in particular a firearm.

Moreover, due to the RF radio emitter 60 being integrated with the limited access element, in particular a firearm, the same can be localized in case it is missing or has been stolen.

An alarm signal can be also used, in particular to be send to the operating center, when monitoring the position of the limited access element with respect to the sensitive areas. In this case, when the limited access element is outside all of its authorized areas or inside one of the prohibited ones, not only its use is prevented but an alarm signal is sent to the operating center.

The integrated intelligent locking system 10 has two main application domains: private domain and public domain.

According to the private domain, the integrated intelligent locking system 10 is designed to be used by the so called “good family father”, i.e. someone who wants to secure/increase the level of safety in the management of their potentially dangerous devices, in particular firearms, in order to avoid accidents, theft and use by unauthorized persons, including young family members.

According to a first function referred to as “unauthorized use”, the integrated intelligent locking system 10 is able to promptly notify the owner when the limited access element associated with the integrated intelligent locking system 10 is removed or, more generally, is moved from a designated storing spot within an authorized area.

This feature allows to advice the owner about a possible use of the limited access element by unauthorized people who, in some way, have come into contact with the same, even if it is within an authorized area, for instance in case of a member of the family.

According to a second function indicated as “theft warning”, the integrated intelligent locking system 10 is able to send an alarm signal to the owner of limited access element, for instance a firearm, associated with such a system by connecting and comparing different information about the firearm, such as its identification, its position and corresponding authorized areas, being thus able to verify whether the firearm has been subtracted from the owner's home.

According to a third function referred to as “localization”, the integrated intelligent locking system 10 is able to report the location of the protected limited access element, in particular a firearm, upon request of the owner, different sensors being used in order to ensure the best possible accuracy.

According to a fourth function indicated as “black box”, the integrated intelligent locking system 10 is used to certify an authorized use of a firearm, to be used as proof in court of where and how much the firearm was used by the owner, particularly to prove personal defense purposes (within the limit permitted and regulated by law).

In this case, the integrated intelligent locking system 10 may activate an information acquisition function recording the conditions that led the owner of a firearm to shoot, just as happens for the public defibrillators or airplanes.

In the case of the private domain, the sensitive zones or security zones within which unlocking in particular of firearms is prevented are defined in the operating center of a government institution such as a city council. Moreover, sensors can be used create “grids” able to identify the integrated intelligent locking system 10 of firearms, to be used in the vicinity of such sensitive areas, for example of a school.

Thanks to the infrastructure 20 associated with the integrated intelligent locking system 10 and a sensor system, it is also possible to count the presence of restricted access elements, in particular firearms, in a specific area, this information being useful for police officers and also for private security guards.

Furthermore, thanks to the registration in the management software 23 it is possible to create a database of owners of firearms provided with the integrated intelligent locking system 10.

The integrated intelligent locking system 10 associated to a firearm may also be provided with additional functions indicated as “weapon out”, which indicates when the weapon has been extracted (for example from the holster), “shot fired” which indicates precisely when the weapon has fired and “man down” which indicates the positioning of the weapon on the ground, as detected by the gyroscope, allowing in particular to launch an alarm of a possible danger situation for the owner.

These additional features can be used, for example, by a private security group that wants to monitor the status of its operators. Alternatively, a monitoring can be provided of a spontaneous or unauthorized demonstration of citizens, to understand if it risks degenerating.

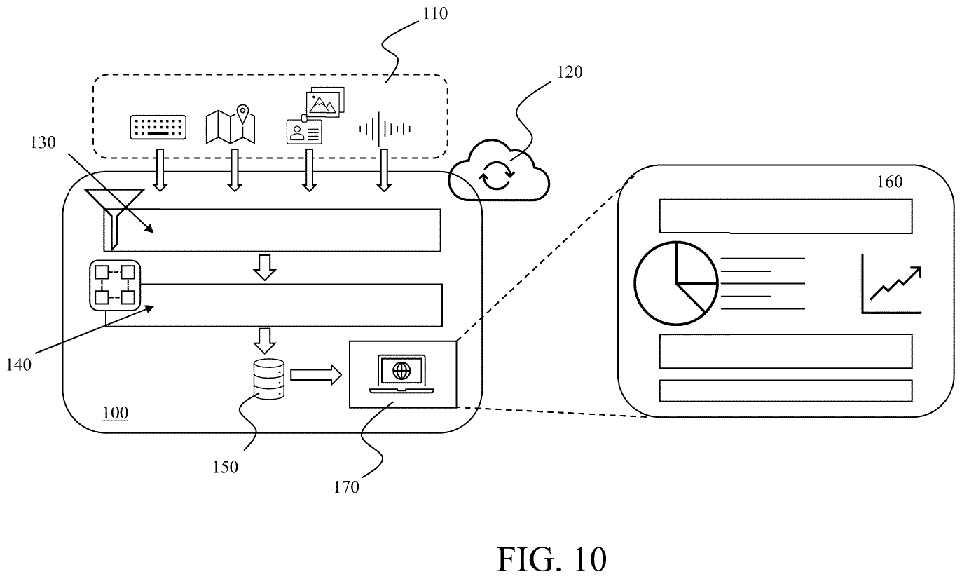

According to an alternative embodiment, as shown in FIG. 10, an analysis data architecture 100 is associated to the operating center of the integrated intelligent locking system.

The analysis data architecture 100 is connected to a plurality of heterogeneous data open sources 110, including Social Networks, chat, video streaming, audio streaming, et al. In particular, different data coming from the plurality of heterogeneous data open sources 110, comprising textual data, audiovisual data, geographic positions, biometric and audiometric data, to name few, are analyzed in cloud based system 120 including a filtering layer 130 and a blockchain layer 140 wherein the data are analyzed in real time and stored in a database 150 so as to be provided as a graphical representation 160 to the operating center 170. The analysis data architecture 100 is aimed to acquire critical elements being diffused in the heterogeneous data open sources 110 and blocking their fakes.

In summary, the integrated intelligent locking system comprising a locking element physically associated to a limited access element associated, a recognition system of authorized user(s) and a detection of the position of the limited access element with respect to sensitive areas, in particular authorized and prohibited areas, guarantee a safe access to hazardous places and a safe use of dangerous tools, in particular firearms.

From the foregoing it will be appreciated that, although specific embodiments of the disclosure have been described herein for purposes of illustration, various modifications may be made without deviating from the spirit and scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An integrated intelligent locking system associated to a limited access element comprising:
a locking element apt to physically prevent an access to the limited access element;
a user recognition device apt to recognize an authorized user; and
a position detector apt to detect the position of the limited access element,
the locking element being triggered into a safe use mode only upon receiving a first authorization command from the user recognition device and a second authorization command from the position detector.

2. The integrated intelligent locking system of claim 1, wherein the user recognition device is a biometric identification engine, being able to recognize the authorized user by means of their biometric data.

3. The integrated intelligent locking system of claim 2, wherein the user recognition device comprising at least one between a voice recognition device and a fingerprint scanner.

4. The integrated intelligent locking system of claim 2, wherein the user recognition device comprises prestored biometric data of an authorized user.

5. The integrated intelligent locking system of claim 1, wherein the user recognition device is apt to recognize a plurality of authorized users.

6. The integrated intelligent locking system of claim 2, wherein the user recognition device comprises an interface apt to collect the biometric data of the user and a memory unit, able to store biometric data of authorized users.

7. The integrated intelligent locking system of claim 6, wherein the user recognition device further comprises an engine being connected to the interface and to the memory unit and apt to compare collected biometric data with stored ones so as to identify a user as an authorized one.

8. The integrated intelligent locking system of claim 1, wherein the user recognition device is configured to send the first authorization command to the locking element only after a user has been positively identified as an authorized user, the first authorization command allowing unlocking the locking element by triggering a safe use mode.

9. The integrated intelligent locking system of claim 8, wherein the user recognition device is a voice recognition device and a specific voice command is required from an authorized user to provide the first authorization command.

10. The integrated intelligent locking system of claim 9, wherein the voice recognition device provide for a background sounds elimination from the voice command.

11. The integrated intelligent locking system of claim 1, wherein the user recognition device is a portable device and comprises radio connection means to the locking element in order to provide the first authorization command.

12. The integrated intelligent locking system of claim 1, wherein the position detector is configured to detect the position of the integrated intelligent locking system and to compare the detected position with sensitive areas.

13. The integrated intelligent locking system of claim 12, wherein the position detector provides the locking element the second authorization command based on the position of the integrated intelligent locking system inside or outside a sensitive area.

14. The integrated intelligent locking system of claim 13, wherein the sensitive areas comprises:
authorized areas wherein the use of the limited access element is only allowed and the second authorization command is provided to the locking element only if the position of the integrated intelligent locking system is within one of the authorized areas; and
prohibited areas wherein the use of the limited access element is never allowed and the second authorization command is provided to the locking element only if the position of the integrated intelligent locking system is outside all the prohibited areas.

15. The integrated intelligent locking system of claim 12, wherein the position detector further comprise an accelerometer, able to detect and provide data relating the movements of the integrated intelligent locking system.

16. The integrated intelligent locking system of claim 1, further comprising a device for remote data transmission.

17. The integrated intelligent locking system of claim 1, being coupled to an infrastructure which includes:
an operating center able to acquire and store an unique identification code and a position of the integrated intelligent locking system; and
a software interface, in turn comprising:
at least one management software; and
a blockchain security system.

18. The integrated intelligent locking system of claim 17, wherein the operating center comprises:
a store unit able to store data of the owners of the integrated intelligent locking systems and provide the same to the integrated intelligent locking system.

19. An integrated intelligent locking system associated to a limited access element comprising:
an RF radio-controlled electromechanical actuator to mechanically forbid the use of the limited access element;
an RF radio emitter; and
a portable computing unit.

20. The integrated intelligent locking system of claim 19 wherein the RF radio-controlled electromechanical actuator comprises:
an electromechanical actuator able to prohibit the use of the limited access element;
a tamper sensor, capable of signaling any attempts of unauthorized access to the portable computing unit;
an RF radio transmitter receiver able to radio connect with the portable computing unit; and
rechargeable battery, able to provide energy to any of the electromechanical actuator, tamper sensor and RF radio transmitter receiver.

21. The integrated intelligent locking system of claim 20 wherein the RF radio transmitter receiver is a very low power radio transceiver using a frequency of 900 MHz or 2.4 GHz.

22. The integrated intelligent locking system of claim 19 wherein the portable computing unit comprises:
interface devices apt to gather biometric data of a user;
a biometric identification engine receiving the biometric data from the interface devices;
peripherals RF radio interface able to radio connect with the RF radio-controlled electromechanical actuator and the RF radio emitter; and
a rechargeable battery able to provide energy to any of the interface devices, the biometric identification engine and the peripherals radio interface.

23. The integrated intelligent locking system of claim 22 wherein the portable computing unit further comprises:
first connection means to the cloud; and
second connection means to the global position system.

24. The integrated intelligent locking system of claim 22 wherein the portable computing unit further comprises:
an AI neural network supervisor being apt to manage tracing functions and authorize the use of the limited access element upon identification of an authorized user by their biometric data.

25. The integrated intelligent locking system of claim 19 wherein the RF radio emitter further comprises:
a position detector;
an accelerometer;
an RF radio transmitter receiver connected to the accelerometer and able to radio connect with the portable computing unit; and
a rechargeable battery, able to provide energy any of the position detector, accelerometer and RF radio transmitter receiver.

26. The integrated intelligent locking system of claim 25 wherein the RF radio transmitter receiver is a very low power radio transceiver using a frequency of 900 MHz or 2.4 GHz.

27. The integrated intelligent locking system of claim 19 wherein the RF radio-controlled electromechanical actuator and the RF radio emitter are on board with the limited access element and the portable computing unit is an external device.

28. The integrated intelligent locking system of claim 19 wherein the limited access element is a firearm.

29. The integrated intelligent locking system of claim 28 wherein the RF radio-controlled electromechanical actuator is positioned in correspondence of the firing mechanism of the firearm and the RF radio emitter is inserted within the gun grip.

30. The integrated intelligent locking system of claim 28 wherein the RF radio-controlled electromechanical actuator is used to block the opening of the gun holster of the firearm and the RF radio emitter is inserted within the gun grip.

31. The integrated intelligent locking system of claim 30 wherein the portable computing unit is inserted within the gun holster.

32. The integrated intelligent locking system of claim 17, wherein the operating center of the infrastructure is associated to an analysis data architecture being connected to a plurality of heterogeneous data open sources providing different data.

33. The integrated intelligent locking system of claim 32, wherein the analysis data architecture is cloud based system including:
a filtering layer;
a blockchain layer; and
a database,
wherein the different data from the plurality of heterogeneous data open sources are analyzed in real time, stored in the database and provided as a graphical representation to the operating center.

34. An architecture comprising:
a locking device;
a portable device; and
an operating center.

35. The architecture of claim 34, wherein the locking device comprises:
an electromechanical actuator;
position detection means;
a rechargeable battery;
a data SIM card; and
an accelerometer and a gyroscope.

36. The architecture of claim 34, wherein the portable device comprises:
interface devices to collect biometric data
a biometric identification engine; and
radio connection means to the locking device.

37. The architecture of claim 34, wherein the operating center performs the following actions:
acquiring and storing data relating to protected elements and to authorized users;
defining sensitive areas wherein the protected elements can access or being used, allowing a remote lock of the protected elements; and
using blockchains to store critical information.
